(19) United States
(12) Patent Application Publication
(10) Pub. No.: US 2006/0017955 A1
(43) Pub. Date: Jan. 26, 2006

(54) Selective graphic instance rendering

(75) Inventors: James E. Owen, Vancouver, WA (US); Burton L. Levin, Lake Oswego, OR (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(73) Assignee: Sharp Laboratories of America, Inc.

(21) Appl. No.: 11/220,074

(22) Filed: Sep. 6, 2005

Related U.S. Application Data
(63) Continuation-in-part of application No. 10/404,201, filed on Mar. 31, 2003.
(63) Continuation-in-part of application No. 10/876,837, filed on Jun. 24, 2004.

(51) Int. Cl. G06F 15/00

(52) U.S. Cl. 358/1.13

(57) ABSTRACT

A system and method are provided for selectively rendering graphic instances in an image driver software application. The method comprises: accepting image data including a plurality of graphic instances from a software application (i.e., a printer driver accepting print data from a document processing application); applying a default first image rendering option to the image data; selecting a first graphic instance in the image data; applying a second image rendering option to the selected first graphic instance; and, generating an image job (i.e., a print job) incorporating the first and second image rendering options. A graphic instance can be a text object, business graphics object, photo object, bitmap, color, a range of colors, an identified region of a page, or vector. Some examples of rendering options that can be selected by the user include halftoning, color management, black generation, undercolor removal, filters, color adjustments, and segmentation-based rendering algorithms.

### RELATED APPLICATIONS

This application is a continuation-in-part of a pending patent application entitled, SYSTEMS AND METHODS FOR CONTEXT-BASED ADAPTIVE IMAGE PROCESSING USING SEGMENTATION, invented by James Owen, Ser. No. 10/404,201, filed Mar. 31, 2003, which is incorporated herein by reference.

This application is a continuation-in-part of a pending patent application entitled, SYSTEMS AND METHODS FOR SEGMENTING PAGES AND CHANGING SETTINGS FOR GRAPHICAL ELEMENTS IN PRINTING, invented by Ferlitsch et al., Ser. No. 10/876,837, filed Jun. 24, 2004, which is incorporated herein by reference.

### BACKGROUND OF THE INVENTION

1. Field of the Invention

This invention generally relates to digital image processing and, more particularly, to a system and method for selecting particular graphic instances from image data, for special rendering treatment.

2. Description of the Related Art

The adjustment of color-rendering techniques for different types of graphics is a common feature available in document and imaging software applications and printer drivers. For example, a user may prefer that their business graphics be rendered more vibrantly than the default setting, or bitmaps made more realistic. Also, scanned halftoned images may need to be de-screened when printed, if the printer also uses halftoning. Further, some users may prefer that computer-generated bitmaps be rendered more vibrant than the default setting, while digital photographs be rendered more realistically.

One conventional mechanism permits rendering options to be selected, within any file, on the basis of the class of the graphics. U.S. Pat. No. 5,704,021, assigned to HP, describes a process that permits a user to select a color rendering option on the basis of object type. The primary limitation of this process is that the same rendering process must be applied to all members of the class. For example, if a user selects a particular rendering option for a photo, that same rendering parameters are applied to all photos in the file. Further, there are only three object types. The classes (object types) provided in this HP patent are “Graphics, Photo, and Text”.

Another conventional solution to this problem involves the use of specialized software applications. One method is to cut a graphic from a compound document, paste it into an application such as Photoshop®, and print the graphic from Photoshop using selected rendering settings. The rest of the compound document is printed from the original application. Another conventional method addresses the problem by providing color rendering on a per-graphic-instance basis in applications that can manipulate compound documents, such as Quark Express and Adobe InDesign. While this technique has advantages, it is limited to the specialized applications that support such capabilities. These applications are expensive, and usually too complex to use for the novice or average user. Alternately stated, this solution is not generally applicable to all software applications.

### SUMMARY OF THE INVENTION

The invention described herein provides an improved method for customizing and correcting the color rendering of a hardcopy document processed by a printer. The invention is applicable for use with a copier, multifunctional peripheral (MFP), or fax device, if these devices have a segmentation or image understanding mechanism that recognizes distinct graphic instances. More generally, the invention permits custom rendering options to be applied to graphic instances in any type of image processing application.

Specifically, the invention permits a user to select the color rendering to be performed on each selected graphic instance in a document during rendering. The user matches an instance, for example a certain bitmap, with the desired color rendering. This process eliminates the need for specialized applications by providing the color rendering control in the printer (image) driver. The invention provides the user with the ability to override the default color rendering of individual graphics instances. The user may select the instance description and the desired rendering using one of the following mechanisms: via a dialog box in a printer driver; as a text description in a dialog box in a printer driver; as a text file in a printer driver; as menu items in a preview; as a profile identifying a graphic instance in multiple print jobs; as an OS selection in a print preview (where override is passed to the driver); or, as a customizable setting in an application (where override is passed to the driver).

Accordingly, a method is provided for selectively rendering graphic instances in an image driver software application. The method comprises: accepting image data including a plurality of graphic instances, from a software application (i.e., a printer driver accepting print data from a document processing application); applying a default first image rendering option to the image data; selecting a first graphic instance in the image data; applying a second image rendering option to the selected first graphic instance; and, generating an image job (i.e., a print job) incorporating the first and second image rendering options.

A graphic instance can be a text object, business graphics object, photo object, bitmap, color, a range of colors, an identified region of a page, or vector. It should be noted that the concept of a graphic instance has a finer granularity than a “class” of graphics or an object type. For example, if photos are a graphics class, then a particular photo, referred to herein as a photo object, is a graphic instance. In one aspect of the method, the selected graphic instance can be identified as a “graphic type”. Then, in response to the instance being identified as a graphic type, the method automatically applies a selected rendering option to each occurrence of the graphical type. For example, if the user identifies a group of vectors representing a company logo as a graphic type, a selected rendering option will be automatically be applied to every occurrence of the vectors (the logo). Like some conventional processes, the user may choose to process a type of graphics. However, it differs in that the user chooses a graphic instance to trigger the processing.

Some examples of rendering options that can be selected by the user include halftoning, color management, black generation, undercolor removal, filters, color adjustments, and segmentation-based rendering algorithms.

Addition details of the above-described method and a printer driver software application for selectively rendering graphic instances are provided below.

### BRIEF DESCRIPTION OF THE DRAWINGS

FIG. 1 is a diagram depicting a conventional printing operation using a raw spool file (prior art).

FIG. 2 is a diagram depicting a spooler subsystem (prior art).

FIGS. 3 and 4 are diagrams illustrating Windows EMF printing operations (prior art).

FIG. 5 is a diagram depicting Microsoft Windows NT and 2000 printing operations (prior art).

FIG. 6 is a diagram depicting a Windows 2000 print process (prior art).

FIG. 7 is a schematic block diagram of a printer driver software application for selectively rendering graphic instances.

FIGS. 8A through 8E are diagrams depicting some examples of graphic instances.

FIG. 9 is a drawing depicting an exemplary UI graphic instance menu.

FIG. 10 is a drawing depicting a variation in the exemplary UI graphic instance menu of FIG. 9.

FIG. 11 is an exemplary dialog box or menu for matching graphic instances to rendering options.

FIG. 12 is a flowchart illustrating a method for selectively rendering graphic instances in an image driver software application.

### DETAILED DESCRIPTION

Many computing device platforms and printing systems are available today and aspects of the present invention may be implemented with many of these systems. However, due to the prevalence of the Microsoft Windows® operating system family, aspects used in conjunction with Windows® systems are typically used to illustrate the invention. Accordingly, details of Microsoft Windows® printing processes are explained below.

Microsoft Windows® operating systems typically employ two file types in the printing process. These file types are Enhanced Metafile (EMF) and raw format (raw) files. Raw format files are device dependent files, which are destined and formatted for a specific device. An example of a raw file is an encapsulated Postscript (PS) file that is formatted for interpretation by a Postscript printer. EMF files are device independent files that contain graphic device interface (GDI) function calls that reproduce an application's graphic elements on a printer. EMF files are used to quickly record a printed document and return system control to a user. After control is returned to the user, the function calls stored in the EMF file may be accessed and sent to the printer in the background.

Files may be recorded for later play back by using a spool file that is written and later despooled to a printing device. Spool files may be used for EMF and raw files. However, a print job may also be written directly to a printing device without using a spool file. Some typical printing process scenarios using raw spool files and EMF spool files are described below to introduce the components, elements and relationships of these processes and how they relate to embodiments of the present invention. These scenarios are derived from information contained in the Microsoft Windows 95® Driver Development Kit (DDK) documentation, the Microsoft Windows 2000® DDK documentation and the Microsoft Windows NT® DDK documentation.

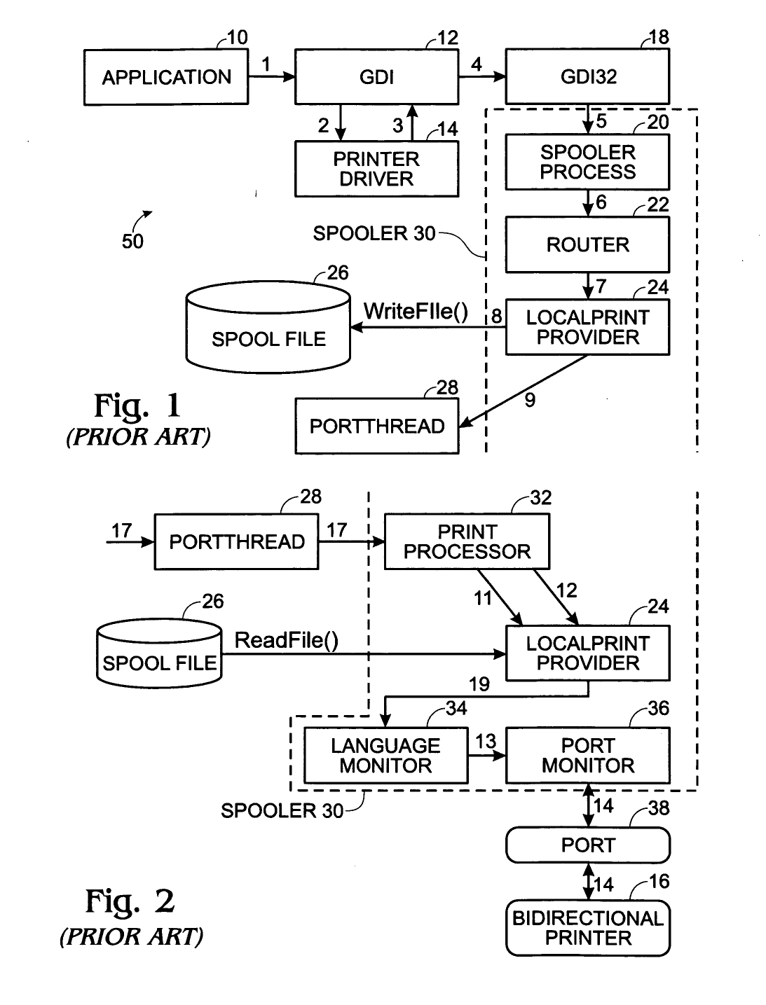

FIG. 1 is a diagram depicting a conventional printing operation using a raw spool file (prior art). Many of the above-mentioned components may be enabled as elements in a computer system 50. The computer system 50 may comprise any type of computing device, including a personal computer, workstation, personal digital assistant, or the like. The computer system 50 typically includes an operating system (not shown). The computer system 50 may run several applications. A single application, application 10 is shown. Examples of applications include word processors, spreadsheets, communication software, and presentation software. Typically, a user of the computer system may utilize application 10 to generate one or more documents. In some aspects, the computer system 50 may further comprise computer network components including other computing devices, servers, routers, hubs, switches and output devices such as displays, printers, plotters, CD writers, tape drives and other devices.

The computer system 50 may be connected to an output device such as a printer (not shown). The output device may be any type of output device that is capable of forming an image and that can be used in combination with the computer system 50. The printer may be used to print one or more documents created by the application 10.

As explained in more detail below, the computer system 50 may comprise an output system or print system for converting an application's output to a format compatible with an output device. An output system or print system may comprise a printer driver, print processor, spooler, print provider, as well as other print system components as described above in relation to Microsoft operating systems. These print system components are software that enable the application 10 to communicate with a printer. When the application 10 needs to print a document, it sends print data to the print system. Print data is data describing the document to be printed. Typically, the print data is a series of commands (e.g., draw a circle, draw a line of text in a particular font, etc.). The printer system accepts the print data from the application 10 and then creates printer ready data. The printer ready data is print data translated into a format that a printer can understand. The format of the printer ready data may depend on the capabilities of the printer. For many low-end printers such as inkjets, the printer ready data is pixel data, i.e., data that may be used to print pixels on a piece of paper. More and more printers are capable of translating images presented in a variety of Printer Description Languages (PDLs), such as PCL (many versions) and PostScript.

An application 10 initiates a print request 1 by calling a graphic device interface (GDI) 12. Application 10 may be a word processor, spreadsheet, browser, database program, or some other program that runs on the underlying operating system. Typically, application 10 will create a device context (DC) and draw an object (i.e., a circle, a line, etc.) to the DC. The application 10 will then call the GDI with a print request directed to a particular printer 16 (FIG. 2) using that DC.

The GDI 12 will call the printer driver 14 associated with the particular printer 16 and request 2 instructions on how to render the object on that particular printer 16. The printer driver 14 will return 3 the instructions on how to render the object on the printer 16. In Windows 95®, used in this printing process example, the printer driver 14 is written in 16-bit code and communicates with a 16-bit GDI 12. This GDI will then pass the print request to a 32-bit GDI (GD132) 18 to handle the 32-bit Windows 95® spooler process. GDI32 makes an interprocess call 5 to the spooler process 20.

Spooler process 20 calls 6 the router 22 to route the print job to printer 16. In this example, illustrated in FIGS. 1-2, the router 22 sends the print job to a local print provider 24. In other scenarios, the router 22 may send print jobs to a network printer through a network print provider (not shown). When the default Windows 95® spooler is used, network print jobs are spooled and despooled on the client machine just as local print jobs. The network print server is contacted only during despooling. Windows NT/2000® client machines handle print jobs to network print servers differently, these machines use remote procedure calls (RPCs) to call the necessary printing application program interfaces (APIs) on the print server. In these NT/2000 scenarios, the print jobs do not show up on the local spooler queue. Rather, spooling and despooling are handled by the print spooler on the print server. This RPC method can be used in conjunction with Windows 95® spoolers also. Print jobs to locally connected printers or locally queued to (e.g., LPR) to network printers are handled similarly to Windows 95, 98 local print jobs.

In this local printing scenario, the router 22 calls the local print provider 24 with the print job. Local print provider 24 writes or “spools” 8 a raw spool file 26 to disk for later access. This is done to avoid waiting for the printer to complete the job before control is returned to the application. These steps from initiating the print request 1 to writing to spool file 26 may be repeated many times. Data may be appended to spool file 26 until an application signals that the print job is complete. The job completion may be signaled with an EndDoc function. Local print provider 24 also starts 9 a background thread 28 that will determine the best time to start playing back or “despooling” the spool file 26 to the printer 16.

FIG. 2 is a diagram depicting a spooler subsystem (prior art). Thread 28 monitors spooler subsystem resources to determine a good time to playback spool file 26. When thread 28 determines that playback should commence, a StartDoc function call 17 is sent to print processor 32 to start a new print processor thread 11. Print processor thread 11 invokes the local print provider 24 with a ReadPrinter function call to read part of the spool file 26. A print processor thread 19 also uses the local print provider 24 to invoke the language monitor 34 with a WritePrinter function call to send data through the physical port 38 connected with the bidirectional printer 16 specified previously.

For raw spool files, the default print processor 32 simply passes data through, without changing or interpreting any of the information. A language monitor 34 is used in this example because the destination printer 16 is a bidirectional printer. When non-bidirectional printers are used, a port monitor 36 is invoked instead of the language monitor 34. A language monitor 34 and port monitor 36 may be separate components or may be integrated into one monitor.

Language monitor 34 calls 13 a port monitor 36 to send print job data to the printer 16. The port monitor 36 then sends 15 the raw data through the physical port 38 to the printer 16. This process of reading from a spool file 26 and forwarding data to the printer 16 may be repeated several times to complete a print job. This is typically repeated until an end-of-file is reached or the job is cancelled. The playback thread 19 is terminated at that point. The combination of spooler process, router, local print provider, print processor, language monitor, and port monitor may be referred to collectively as a “spooler” 30.

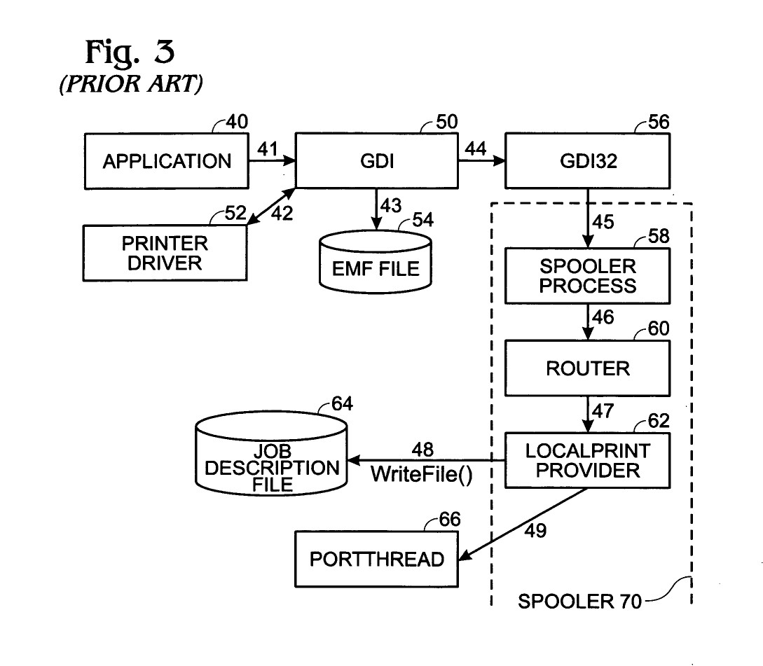

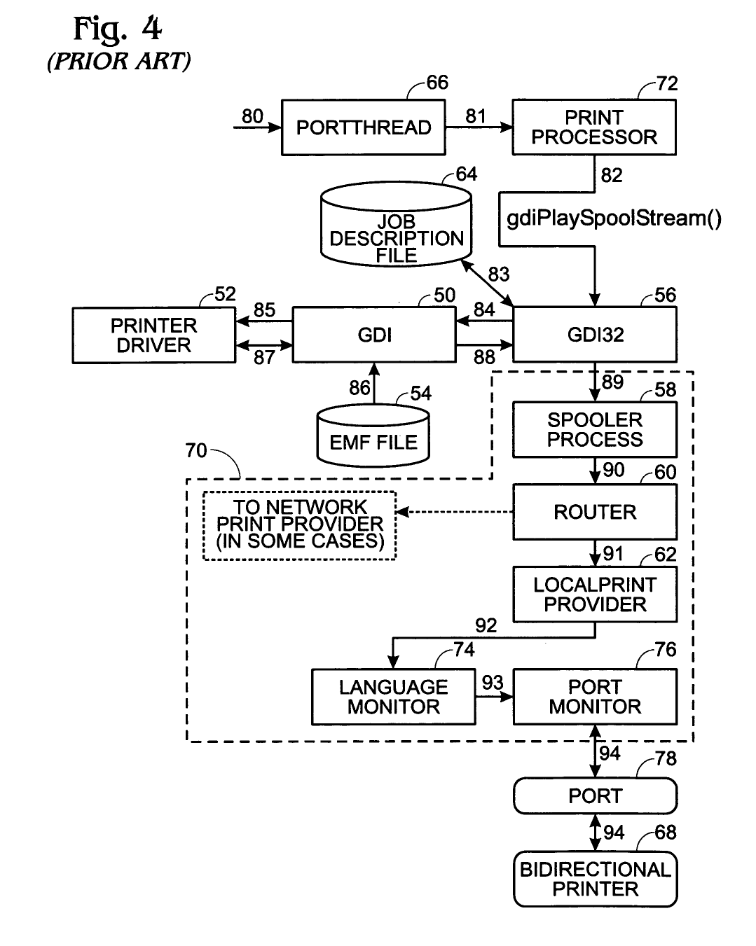

FIGS. 3 and 4 are diagrams illustrating Windows EMF printing operations (prior art). When Windows Enhanced Metafile (EMF) format files are used in the printing process of Windows 9.x systems, process components interact differently than with raw files. An example printing process, shown in FIGS. 3 and 4 illustrates the printing process using EMF files. This process typically commences when an application 40 creates a printer DC and draws an object to the DC (not shown). The application 40 then calls 41 GDI 50 with an EMF spooling request for a designated printer 68. GDI 50 queries 42 the printer driver 52 associated with the designated printer 68 to determine whether the driver 52 supports EMF spooling. If the driver 52 supports EMF spooling, GDI 50 changes the printer DC to an EMF DC and writes 43 the instructions for rendering the object to the EMF DC 54 (creates EMF files). GDI 50 then passes 44 the print request to the 32-bit GDI (GDI32) 56 because, in this example the Windows 95® spooler process is 32-bit code. GDI 32 subsequently makes an interprocess call 45 to the spooler subsystem 70 with a description of the print job.

The spooler process 58 (SPOOL32.EXE), in the spooler system 70, calls the router 60 to pass the print job description to the print provider 62 that can reach the designated printer 68. In this example, a local print provider 62 is used, but a network print provider may also be used. When the default Windows 95® spooler is used, network print jobs are spooled and despooled on the client machine just as local print jobs. The network print server is contacted only during despooling. Windows NT/2000@ client machines handle print jobs to network print servers differently, these machines use remote procedure calls (RPCs) to call the necessary printing application program interfaces (APIs) on the print server. In these NT/2000 scenarios, the print jobs do not show up on the local spooler queue. Rather, spooling and despooling are handled by the print spooler on the print server. This RPC method can be used in conjunction with Windows 95® spoolers also.

When the router 60 has called the print provider 62, the local print provider 62 creates 48 a job description file 64 and adds 48 a record to the job description file 64 each time it is called for the job until all the EMF page files have been spooled and each EMF file name and location is recorded in the job description file 64. When information about the last EMF file in the print job has been recorded, the local print provider 62 will call the spooler process 58 with an EndDoc function call. This signals the spooler process 58 that the complete job is spooled and ready for despooling. For multi-page jobs, these steps from initial spooling request 41 to job description file recording 48 are repeated for each page of a job.

When EMF file spooling is complete, the spooler process 58 sets a ReadyToPrint attribute on the print job and initiates an event 49 that signals to the port thread 66 that a job is available for printing. Port thread 66 responds to this event by determining the best time to start the despooling process and, at that time, loads 81 the print processor 72, as shown in FIG. 4. The print processor 72 will determine that the file format is EMF and call GDI32 56 with a Windows 95® function call 82.

GDI32 then invokes a gdiPlaySpoolStream function to read 83 from the job description file 64, which provides a fully qualified path to an EMF spool file 54. Through the job description file 64, which comprises a list of path names to EMF files, GDI32 knows about all the pages in the print job. The GDI32 gdiPlaySpoolStream function also calls GDI 50, using a thunk (a call across platform code) built into GDI32, with the path to the EMF spool file to render the page. GDI 50 only knows about one page in the print job at a time.

GDI 50 calls the printer driver 52 associated with the designated printer 68 chosen in application 40 and obtains a DC for the printer 68. GDI 50 then reads page-rendering instructions from the spooled EMF file 54 and passes 85 them one at a time to the printer driver 52 which uses as many instructions as are necessary to render the first part of the page. When the 16-bit printer driver 52 renders a part of the page, it passes 87 the printer-specific raw page data back to the GDI 50 which, in turn, passes 88 the raw data to GD132 56. GDI32 56 then passes 89 the raw data to the spooler process 58 which then follows the same procedures it would for a raw format files as explained above.

Spooler process 58 calls 90 the router 60 to route the print job to printer 68. In this example, illustrated in FIGS. 3 and 4, the router 60 sends the print job to a local print provider 62. In other scenarios, the router 60 may send print jobs to a network printer through a network print provider (not shown). In this local printing scenario, the router 60 calls the local print provider 62 with the print job. Local print provider 62 invokes the language monitor 74 with a WritePrinter function call to send data through the physical port 78 connected with the bidirectional printer 68 specified previously.

A language monitor 74 is used in this example because the destination printer 68 is a bidirectional printer. When non-bidirectional printers are used a port monitor 76 would be invoked instead of the language monitor 74. A language monitor 74 and port monitor 76 may be separate components or may be integrated into one monitor. Language monitor 74 calls 93 a port monitor 76 to send print job data to the printer 68. The port monitor 76 then sends 94 the raw data through the physical port 78 to the printer 68.

Parts of EMF pages are processed in this manner and printed until an entire page is printed. GD132 56 then gets the path to the EMF spool file for the next page and calls GDI 50 to use the instructions in that EMF file to render the next page of the print job. The print job is finished when all the paths to EMF spool files are used up.

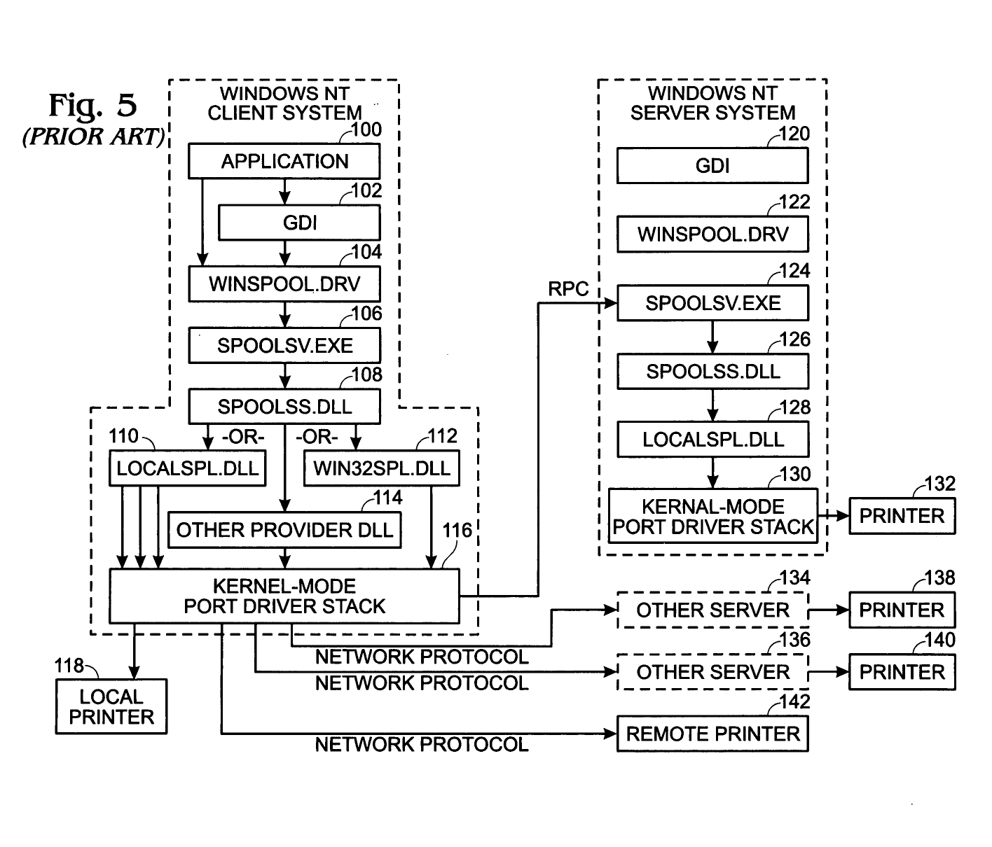

FIG. 5 is a diagram depicting Microsoft Windows NT and 2000 printing operations (prior art). Other versions of the Microsoft Windows operating systems, such as Windows NT and 2000 may use different printing processes. These processes may be used to print data to local, network, and remote printers either directly or through a network print server. EMF data may also be processed differently. For example, in Windows NT and 2000, the entire EMF data for all pages is passed to GdiPlayEMF( ) in one pass, rather than one page at a time. If the EMF data is to be queued on a print server, the EMF data is passed directly to the print server without rendering on the client. A mirror copy of the driver on the server renders the EMF data instead.

Typically, a user will employ an application 100 to create a print job by calling GDI 102 functions. The GDI 102 and/or application 100 will then call Winspool.drv 104, which is a client interface into the spooler. This client interface, Winspool.drv 104, exports the functions that make up the spooler's Win32® API and provides RPC stubs for accessing the server. The print job is then forwarded to the spooler's API server, Spoolsv.exe 106, which can be implemented as a Windows 2000 service that is started when the operating system is started. This API server module exports an RPC interface to the server side of the spooler's Win32® API. This module implements some API functions, but most function calls are passed to a print provider by means of the router, spoolss.dll 108.

The router 108 determines which print provider to call, based on a printer name or handle supplied with each function call, and passes the function call to the correct provider 110, 112 or 114. If the selected printer is managed by the client system, the print job is handled by the local print provider, localspl.dll 110. Printers managed by the local print provider 110 do not have to be physically local to the client, they may also be directly connected to network cards without using a server. When these printers are used, the print job is passed to the kernel-mode port driver stack 116 and on to the printer 118.

When printers located on a Windows NT/Windows 2000 server are selected, the router 108 directs the print job to the network print provider, Win32spl.dll 112. This network provider uses RPC to redirect calls from the client's router to the network server's spoolsv.exe process l24, which forwards the print job to the network server's router 126. Because the network printer is local to the print server system, the network server router 126 routes the job to the server's local print provider 128. The job is then directed to the server's kernel-mode port driver stack 130 and out to the selected network printer 132.

Remote printers may also be used with these systems. When a remote printer is selected, the client router 108 may direct the print job to the local print provider 110, which will forward the job to the kernel-mode port driver stack 116 and on to the remote printer 142 using a network protocol. When the local print provider 110 accesses a remote printer 142, the provider 110 uses a port monitor that can use network protocols recognized by the remote printer or its server.

Printers managed by non-Windows NT/2000 servers (e.g., Novell servers) may also be accessed through this print system. This may be achieved by using a local print provider 110 that directs the print job to the kernel-mode port driver stack 116 and on to the printer's server 136 using a type of network protocol. The server 136 then directs the job to the destination printer 140. This may also be achieved using a customized print provider 114 which sends the job to the kernel-mode port driver stack 116 which uses a network protocol to send the job on to the printer's server 134, which then directs the job to the destination printer 138.

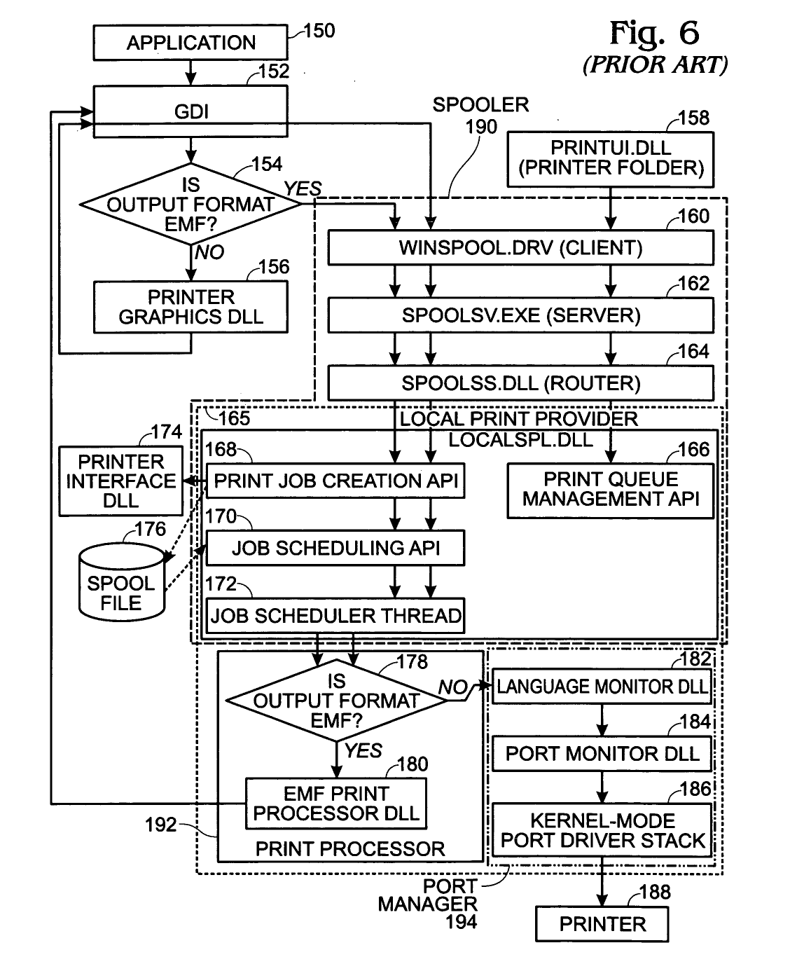

FIG. 6 is a diagram depicting a Windows 2000 print process (prior art). In this process, an application 150 is used to create a print job with the Graphics Device Interface (GDI) 152. When the print job's initial output file is in raw format 154, the printer driver's printer graphics DLL 156 works in conjunction with the GDI 152 to create a print job that is sent to the client interface 160 of the spooler. Client interface 160 sends the job to the API server 162, which forwards the job to the router 164. In this example, the router 164 sends the job to the local print provider 165 as it is a local print job.

Within the local print provider 165, a print job creation API 168 is invoked. This API 168 accesses the printer driver's printer interface DLL 174 and creates a job spool file 176. The job creation API 168 also forwards job information to the job scheduling API 170, which initiates a job scheduler thread 172.

At this point, the file format is checked 178. If the initial job file is in a raw format already, the job is sent to the language monitor DLL 182 and on to the port monitor 184, which sends the job to the kernel-mode port driver stack 186. Port driver stack 186 sends the job to the selected printer 188 for final printing.

When an application 150 creates a print job with GDI 152 in EMF format, the job is sent 154 to a client spooler interface 160. Client interface 160 sends the job to the API server 162, which forwards the job to the router 164. Again, in this example, the router 164 sends the job to the local print provider 165 because the print job is local.

Within the local print provider 165, a print job creation API 168 is invoked. This API 168 accesses the printer driver's printer interface DLL 174 and creates a job spool file 176. The job creation API 168 also forwards job information to the job scheduling API 170, which initiates a job scheduler thread 172.

At this point, the file format is checked 178. If the initial job file is in EMF format, the job is sent to the print processor DLL 180, which directs the job back to GDI 152 for conversion to raw format with the help of printer interface DLL 174. The converted job is then sent back through the spooler client interface 160, API server 162, and router 164 to the print provider 165. In the local print provider, the job is processed by the print job creation API 168, job scheduling API 170, and job scheduler thread 172. Because the job is now in raw format, the job is sent to the language monitor DLL 182 and on to the port monitor DLL 184 and kernel-mode port driver stack 186 before arriving at the destination printer 188.

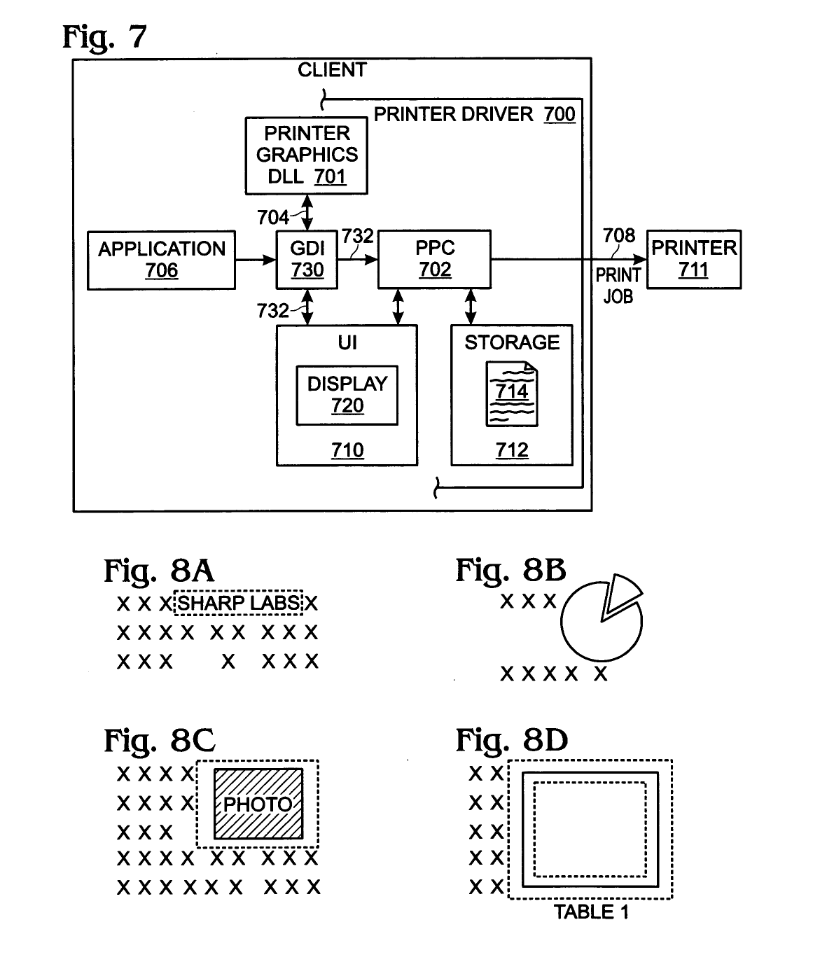

FIG. 7 is a schematic block diagram of a printer driver software application for selectively rendering graphic instances. The printer driver 700 comprises a printer graphics DLL 701 and a print processor component (PPC) 702 having interfaces on line 704 and 732, respectively, to accept print data (i.e. EMF data) from a source document processing software application 706.

The PPC 702 has an interface on line 708. The PPC 702 plays back the EMF instructions through GDI 730, which sends the instructions to the printer graphics DLL 701 through its interface 704. The printer graphics DLL 701 translates the instructions to ones suitable for the printer and writes them back to GDI 730, which passes them on to the PPC 702. The first time the PPC 702 is called, it is getting EMF instructions, and the second time it is called, it receives RAW instructions and passing them on to the Printer. Generally, it can be said that the PPC 702 supplies a print job on line 708. A rendering user interface (UI) 710 is connected to the print processor component 702 for selecting a first graphic instance in the print data. The print processor component 702 forwards instructions to the printer graphics DLL 701 for generating a print job incorporating a first image rendering option as a default and automatically applies a second image rendering option to the first graphic instance. The print job is sent to printer 711. In one aspect, the first graphic instance is identified as a first graphical type. Then, the PPC 702 directs the printer graphics DLL 701 to apply the second rendering option to the identified occurrence of the first graphic instance in the print job. Note, the default rendering option may, or may not be selectable by the user, depending upon the particular driver.

The print processor component 702 can forward processing instructions to the printer graphics DLL 701 by either altering the DevMode structure, or by embedding EMF comments when playing back the EMF file. This aspect makes it easy for a UI to display a preview where the user can select the graphic instance, since the OS has built-in functions to display EMF files on the screen.

In other aspects, the printer driver 700 operates without a PPC 702. For example, a printer graphics DLL can access the EMF files directly, save the EMF files, and start up a custom application that can print the EMF files. A UI can be displayed by either the printer graphics DLL or the application. In another aspect, EMF files are avoided. Instead, graphics instructions are captured and rendered directly in a UI. Since the printer graphics DLL input instructions are not identical to EMF instructions, custom code for on-screen rendering is implemented.

As used herein, a “graphic instance” is defined as a particular, distinguishable occurrence of a graphic or image representation. A graphic instance has a finer granularity than a class of graphics, an object type, or even a particular example of an object type. As opposed to simply differentiating graphics into the general categories of text, photos, and bitmaps, a graphic instance can be selected as a particular member of a class. A graphic instance can be a text object, business graphics object, photo object, bitmap, color, a range of colors, an identified region of a page, or vector. For example, if “photos” are a graphics class, then a particular photo, referred to herein as a photo object, is a graphic instance. In fact, multiple occurrences of the exact same graphic (i.e., Uncle Bob's picture) can be distinguished from one another and identified as different graphic instances. For example, the first occurrence of Uncle Bob's picture (a first graphic instance) can be rendered differently that the second occurrence of the same picture (a second graphic instance). Alternately, multiple occurrences of the same graphic may all be identified as the same graphic instance, referred to herein as a graphic type, and rendered in an identical manner. The printer driver is not limited to any particular group of graphic instances. In fact, the only limitation to creating and using a graphic instance is in the ability of the PPC 702 to segment and identify instances in the print data. This embodiment makes it easy for the UI to display a preview where the user can select the graphic instance, since the OS has built in functions to display EMF files on the screen.

FIGS. 8A through 8E are diagrams depicting some examples of graphic instances. In FIG. 8A, the phrase “Sharp Labs” is an example of a text object. In FIG. 8B, a “pie-chart” is shown as an example of a business graphics object. In FIG. 8C, the top right-hand corner of a page is an example of an identified region of a page. For example, a user may use this method to select a photo, placed in the top right-hand side of a page, for a modified rendering option. In FIG. 8D, a set of four lines defining a “box” structure is an example vector. In FIG. 8E, a bitmap is identifiable as distinct from the text.

There is a relationship between a graphic object type and a graphic object instance. A graphic object type can be defined by many algorithms. In a print job, the algorithm may find X instances of this type. A user may choose to apply a different rendering process to Y of the X instances.

One possible algorithm is to identify a subset of the drawing commands that are proximate to each other. For example, lines, circles, and squares that are within ½ inch of each other. Or, for a text paragraph, the identification may be—all the text graphics that are within ½ inch of each other and placed in equally spaced rows. Another algorithm is—all the graphics within a rectangle drawn on the screen by the user.

Although specific examples have not been shown of a color or range of colors being used as a graphic instance, it can be easily imagined that a user may select a particular color, or a range of colors (i.e., a “blue sky”) form a photo, for example, for a non-default rendering option.

Returning to FIG. 7, the printer driver 700 may further comprise a storage medium 712, or the printer driver may have access to a storage medium, for storing a print job-rendering template 714 incorporating the second image rendering option for the selected first graphic instance. If the PPC 702 accepts subsequent print data, and the rendering UI 710 selects the template 714 from the storage medium 712, then the PPC 702 generates (sends instructions for the printer graphics DLL 701 to generate) a print job for the subsequent print data in response to the print job-rendering template. For example, if the same job is sent to the printer at a later time, the rendering options that were applied to the original job can be used, if the options were stored as a template. Even if the subsequent print job is different from the original, the template can be used to identify a graphic instance (i.e., a photo) and the same rendering option to be applied.

Some examples of image rendering options that can be applied to the selected graphic instance include halftoning, color management, black generation, undercolor removal, filters, color adjustments, and segmentation-based rendering algorithms. The printer driver 700 is not necessarily limited to a particular group of image rendering options, as other conventional rendering applications would also be applicable. In one aspect, the rendering UI 710 includes a display 720 for visually previewing the print data and identifying a graphic instance.

For example, CMY (cyan/magenta/black) overprinting doesn't always produce sufficiently high ink density in shadows. To increase the tonal range in shadows, black may be added. Black can be added undercolor removal (UCR) or gray component replacement (GCR).

Halftoning refers to the process of printing an image with one continuous color (grayscale) or four colors (color), relying on the illusion that closely spaced pixels appear as a continuous color. That is, a continuous color can be made to appear darker by packing the pixels closer together.

Color management is a process that applies transformations to the numbers representing colors, to get accurate results. These transformations usually involve a characterization of the input device and the output device. So, to obtain the same colors in printed document, as seen in a scanned version of the document, a user may choose to print the same colors seen on their monitor. In this case, color management is performed on the monitor and printer profiles.

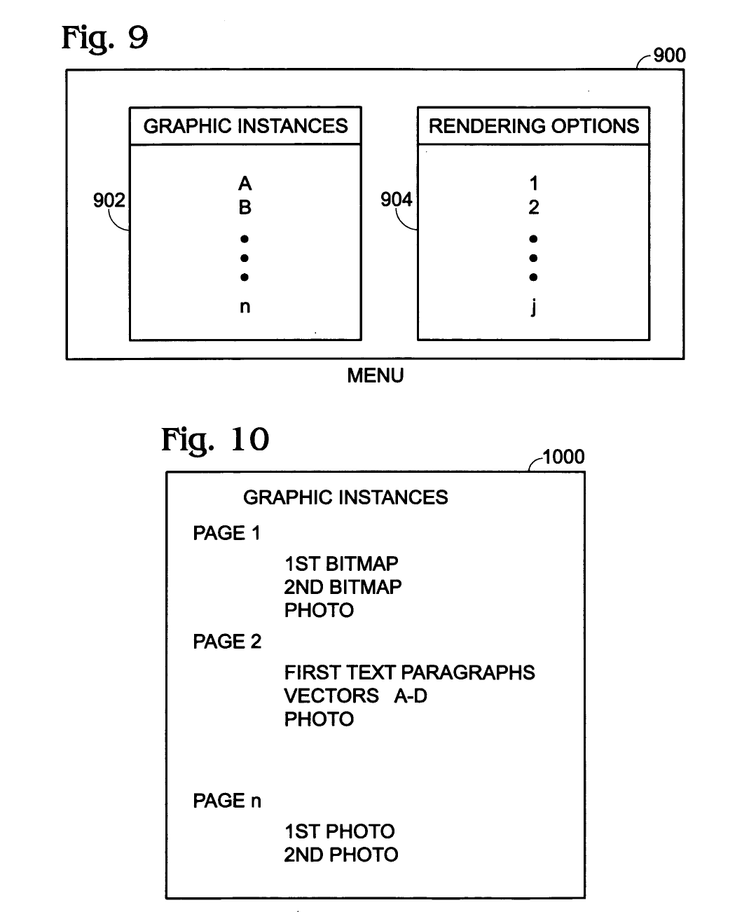

FIG. 9 is a drawing depicting an exemplary UI graphic instance menu. The rendering UI display is capable of depicting a UI graphic instance menu 900 for accessing a list 902 of graphic instances. Using a mouse or keyboard for example, the menu 900 can be used for selecting a graphic instance from the list 902. Further, the menu 900 can be used to access a list 904 of image rendering options, and select image rendering option from the list 904, for association with the first graphic instance.

FIG. 10 is a drawing depicting a variation in the exemplary UI graphic instance menu of FIG. 9. As shown, the rendering UI display menu presents a hierarchical outline 1000 of graphic instances differentiated by print job page number.

In other variations of the printer driver, bitmaps can be differentiated by print job page number or by sequence. Text can be differentiated by print job page number, font, or size. Vectors can be differentiated by print job page number, shape, size, font, location of a print job page, or regions defined by closed vector shapes.

In another aspect (see FIG. 7), additional printer driver functionality is associated with the GDI 730, which sends option inquiries to the printer driver 700; either to the printer graphics DLL on line 704, or the PPC 702 on line 732. In this aspect, the rendering UI 710 is embedded with, or connected via line 732 (as shown), the GDI 730, and it displays the print options described by the print driver. As described above, display 720 presents a list of graphic instances and a list of image rendering options. The menu is used for selecting an image rendering options from the list, for association with a selected graphic instance. The GDI 730 sends the graphic instance and image rendering option selections to the print driver, again either to the printer graphics DLL via the interface on line 704, or to the PPC via the interface on line 732. In the application variation, the instances and rendering option selections can be embedded in the print data. Alternately, an application directs graphic instance queries to the driver (bypassing the GDI).

### Functional Description

The invention permits a user to easily identify one or more different graphic instances in a document, select a preferred image rendering option, such as halftoning and/or color matching, for each of the graphic instances, and then print the document in accordance with the rendering options selected for each instance. While specialized conventional applications have been able to apply rendering options to individual graphics instances, with a limited set of functions such as ICC profiles and postscript rendering, these types of rendering options have never been available in a printer drivers or OS. In a printing system such as an inkjet color printer coupled through a printer driver to a host computer, the present invention method permits default halftoning techniques and default color-matching maps to be overridden.

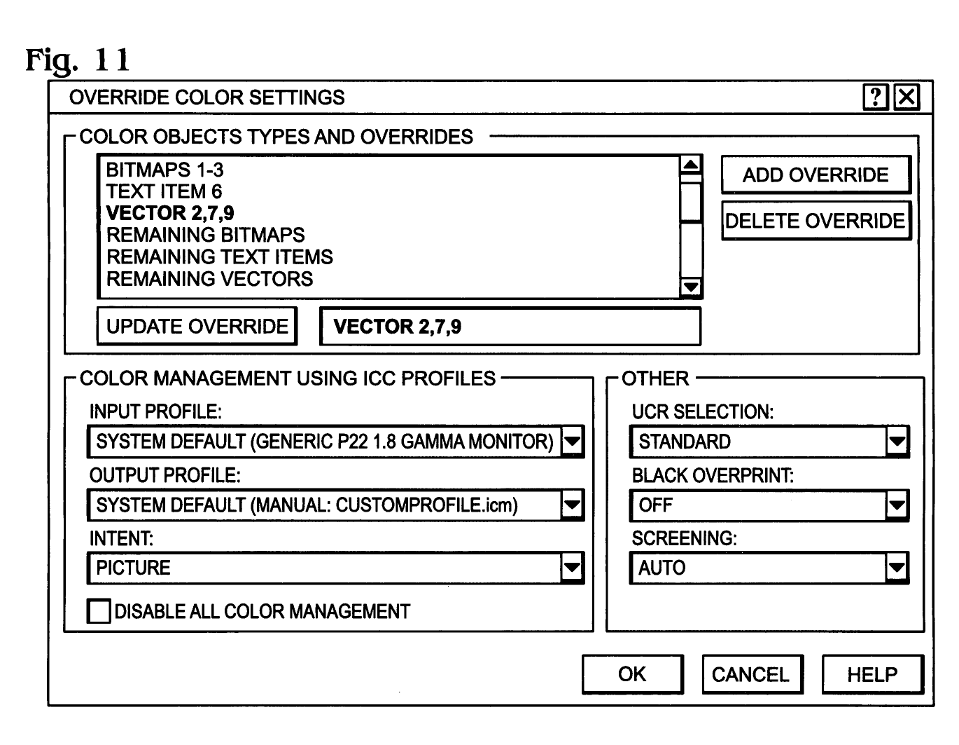

FIG. 11 is an exemplary dialog box or menu for matching graphic instances to rendering options. In one aspect, the user provides a description of the instances and their preferred rendering in a printer driver without a preview. The description can be textual, that is, entered in a text file or a dialog box, or can be a combination of check boxes, lists and radio buttons. While this aspect is not very intuitive, it is easy to implement and it lends itself to automation.

The list box in Color Object types and overrides contains default settings for bitmaps, text and vectors at the bottom of the list (the items begin with the word “Remaining”). In the shown dialog, a user has added overrides in the three items above the default settings: the first item overrides Bitmaps 1, 2, and 3. The second item overrides the 6^{th} text item, and the third item overrides Vectors 2, 7, and 9. When a user selects an item in the list box, all the fields in the rest of the dialog box are updated to reflect the settings for the item; this includes the settings under Color Management and Other. In this way, the driver allows the user to visually confirm his choices.

The Add Override button permits the addition of an item to the list box. The Delete Override button allows the deletion of any one override (it is disabled when a default setting is selected). When an Override item is selected, its text is shown in the editable field below. Clicking on the Update Override button updates the selected item in the list box.

In another aspect, the text is presented in a large field in a dialog box, or the dialog box may be a field containing the name of the file. The text could look as follows:
[Halftoning]
Default=Threshold Array 16×16
Error Diffusion=Image 1(page 2), Image 5(page 4)
Threshold Array 24×24=Image 2(page 2), Text in Paragraph 5(page 3)
[Color Management]
Default=SharpAR33, Colorometric
Sharp AR33, Saturated=Image 2(page 2), Text in Paragraph 5(page 3)

In a different aspect, the name of a job-rendering template text file can be included in the print dialog. The text file contains the selected graphic instances and corresponding rendering options.

In another aspect, a preview of the printout can be displayed on a screen. This aspect permits a user to intuitively choose specific instances and their rendering.

In one aspect, a separate application generates a driver preview that permits a user to select the rendering of the individual instances. The settings are stored in a database (i.e. registry or internal database). The driver recognizes if an element has a stored setting, so that the next time the driver is used, and the same graphic instance is printed (from any document), it uses the stored settings.

Bitmaps are one graphic instance that is likely to benefit from specific user-selected overrides. For example, if a user prints a pamphlet containing a picture that needs de-screening, they may use a previewer to select the de-screening option for this picture. The driver records enough information in its database to recognize that object, whether it appears in the current document or any other document printed with this driver. This aspect permits the user to select a specific rendering for a particular bitmap. Then, regardless of what document is printed, if that document includes the particular bitmap, the bitmap is always rendered the same way. The settings can store the full graphic objects for comparison, or they can store a smaller characterization of the bitmap, such as a checksum or a few sequences of pixels.

In another aspect, an OS that queries a printer driver for rendering options, presents a print preview, and permits a user to select rendering options. The OS then passes these settings back to the application or driver. This aspect permits a user to select the different printer specific rendering options within an OS standard print preview.

In a different aspect, an application queries the driver for rendering options, and allows the user to associate options for graphic instances in the document. The application can save these driver specific rendering options for each graphic instance in the document format itself. The next time the user works on the document, these custom rendering options are remembered.

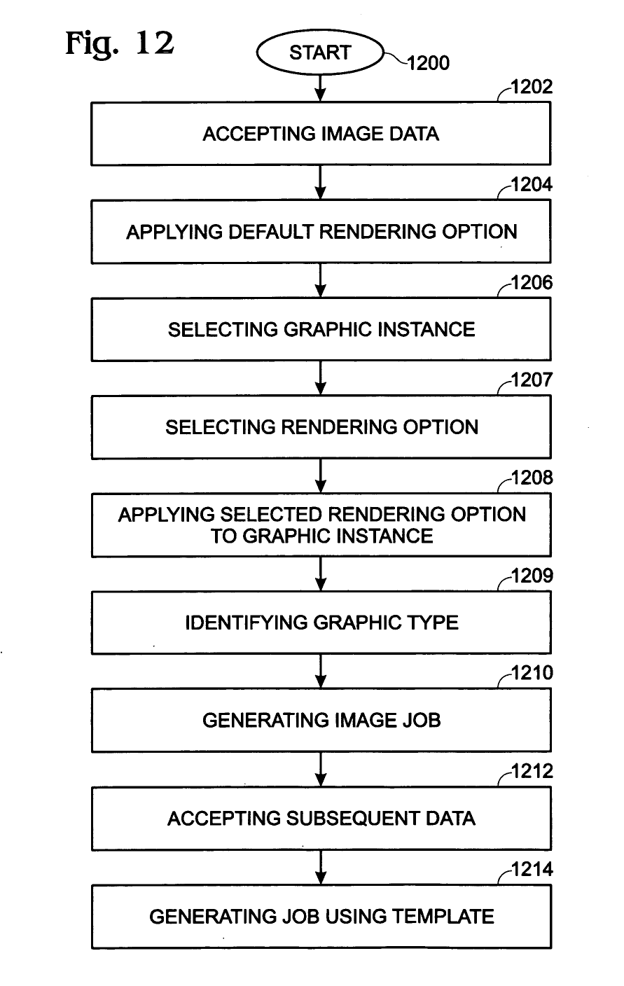

FIG. 12 is a flowchart illustrating a method for selectively rendering graphic instances in an image driver software application. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 1200.

Step 1202 accepts image data including a plurality of graphic instances, from a software application. For example, a print driver may accept print data from a source document processing application in a format such as OS specific graphics (GDI), OS printer graphics (DDI), document processing application file formats, and graphics files including TIFF, PDF, and BMP. Step 1204 applies a default first image rendering option to the image data. Step 1206 selects a first graphic instance in the image data. Step 1208 applies a second image rendering option to the selected first graphic instance. Step 1210 generates an image job incorporating the first and second image rendering options. For example, Step 1210 may generate a print job incorporating the first and second image rendering options in a format such as a proprietary Raster format, PDL, PCLXL, or PS.

In one aspect, generating the print job incorporating the first and second image rendering options in Step 1210 may include substeps (not shown). Step 1210a generates a print job with the default first image rendering option applied to the first graphic instance. Step 1210b sends the second image rendering option, as applied to the first graphic instance, in a file appended to the print job. In another aspect, Step 1210c sends the second image rendering option, as applied to the first graphic instance, in a file to the source document processing application as instructions for subsequent print data submissions.

Accepting the image data with the graphic instances in Step 1202 may include accepting image data with a graphic instance such as a text object, business graphics object, photo object, bitmap, color, a range of colors, an identified region of a page, or vector. Details of these graphic instances have been provided above.

In one aspect, Step 1209 identifies the first graphic instance as a first graphic type. Then, in response to identifying the first graphic type, Step 1210 automatically applies the second image rendering option to each occurrence of the first graphical type.

In another aspect, Step 1210 additionally generates a print job-rendering template. Then, Step 1212 accepts subsequent print data, and Step 1214 generates a subsequent print job for the subsequent print data with the print job-rendering template.

In a different aspect, Step 1207 selects the second image rendering option for the selected first graphic instance. As explained above, possible rendering options include halftoning, color management, black generation, undercolor removal, filters, color adjustments, and segmentation-based rendering algorithms.

In another aspect, selecting the first graphic instance in the print data (Step 1206) includes substeps (not shown). Step 1206a, at a user interface (UI) display, visually previews the print data. Step 1206b identifies a graphic instance on the display. Step 1206c uses the UI to select the identified graphic instance as the first graphic instance.

In a different aspect, Step 1206 includes alternate substeps (not shown). Step 1206d, at a UI graphic instance menu, accesses a list of graphic instances. This process may include a prior step of segmenting or identifying the graphic instances in the received image data. Step 1206e selects the first graphic instance from the list. Then, selecting the second image rendering option for the selected first graphic instance in Step 1207 includes substeps (not shown). Step 1207a, at a UI rendering menu, accesses a list of image rendering options. Step 1207b selects the second image rendering option from the list, for association with the first graphic instance.

In another variation, selecting the first graphic instance in the print data includes accessing a UI with a hierarchical outline of segmented graphic instances differentiated by print job page number. Alternately, Step 1206 accesses a UI with graphic instances such as bitmaps differentiated by print job page number, bitmaps differentiated by sequence, text differentiated by print job page number, text differentiated by font, text differentiated by size, vectors differentiated by print job page number, vectors differentiated by shape, vectors differentiated by size, vectors differentiated by font, vectors differentiated by location of a print job page, or regions defined by closed vector shapes. The method, however, is not limited to any particular means of identifying or selecting a graphic instance.

In a different aspect, Step 1206 includes using a UI display to visually preview a dialog box cross-referencing graphic instances with default rendering options. Then, Step 1207 selects the second image rendering option by using the UI to change from the default rendering option, to the second rendering option, for the first graphic instance.

In another aspect, Step 1206 includes a different set of alternate substeps (not shown). Step 1206f accepts a query from an operating system (OS) or an application, associated with the print driver accepting the first print data. Step 1206g, at an OS UI display, presents a list of graphic instances. Step 1206h selects the first graphic instance from the list. Then, Step 1207 includes some alternate substeps (not shown). Step 1207c, at the OS UI display, presents a list of image rendering options. Step 1207d selects the second image rendering option from the list, for association with the first graphic instance. Step 1207e sends the graphic instance and image rendering option selections to the print driver.

In another variation, Step 1206 includes yet another alternate set of substeps (not shown). Step 1206i, at a UI, selects a table including lists of graphic instances and rendering options. Step 1206j selects the first graphic instance from the list. Then, Step 1207 cross-references a rendering option to the selected graphic instance.

A system and method has been provided for selecting rendering options to be applied to particular graphic instances. The invention has primarily been presented in the context of a printer driver, as a clear illustration. However, the invention is not limited to merely this example, as it has application to any image rendering process, regardless of whether the image data is printed of displayed. Other variations and embodiments of the invention will occur to those skilled in the art.

We claim:

1. In an image driver software application, a method for selectively rendering graphic instances, the method comprising:
accepting image data including a plurality of graphic instances, from a software application;
applying a default first image rendering option to the image data;
selecting a first graphic instance in the image data;
applying a second image rendering option to the selected first graphic instance; and,
generating an image job incorporating the first and second image rendering options.

2. The method of claim 1 wherein accepting the image data with the plurality of graphic instances includes accepting image data with a graphic instance selected from the group comprising a text object, business graphics object, photo object, bitmap, color, a range of colors, an identified region of a page, and vector.

3. The method of claim 1 wherein accepting the image data includes a print driver accepting print data from a source document processing application; and,
wherein generating the image job includes generating a print job incorporating the first and second image rendering options.

4. The method of claim 3 further comprising:
identifying the first graphic instance as a first graphic type; and,
in response to identifying the first graphic type, automatically applying the second image rendering option to each occurrence of the first graphical type.

5. The method of claim 3 wherein generating the print job incorporating the first and second image rendering options includes generating a print job-rendering template; and,
the method further comprising:
accepting subsequent print data; and,
generating a subsequent print job for the subsequent print data with the print job-rendering template.

6. The method of claim 3 further comprising:
selecting the second image rendering option for the selected first graphic instance from the group comprising halftoning, color management, black generation, undercolor removal, filters, color adjustments, and segmentation-based rendering algorithms.

7. The method of claim 3 wherein selecting the first graphic instance in the print data includes:
at a user interface (UI) display, visually previewing the print data;
identifying a graphic instance on the display; and,
using the UI to select the identified graphic instance as the first graphic instance.

8. The method of claim 3 wherein selecting the first graphic instance in the print data includes:
at a UI graphic instance menu, accessing a list of graphic instances; and
selecting the first graphic instance from the list;
wherein selecting the second image rendering option for the selected first graphic instance includes:
at a UI rendering menu, accessing a list of image rendering options; and,
selecting the second image rendering option from the list, for association with the first graphic instance.

9. The method of claim 3 wherein selecting the first graphic instance in the print data includes accessing a UI with a hierarchical outline of segmented graphic instances differentiated by print job page number.

10. The method of claim 3 wherein selecting the first graphic instance in the print data includes accessing a UI with graphic instances selected from the group comprising bitmaps differentiated by print job page number, bitmaps differentiated by sequence, text differentiated by print job page number, text differentiated by font, text differentiated by size, vectors differentiated by print job page number, vectors differentiated by shape, vectors differentiated by size, vectors differentiated by font, vectors differentiated by location of a print job page, and regions defined by closed vector shapes.

11. The method of claim 5 wherein selecting the first graphic instance in the print data includes, at a UI display, visually previewing a dialog box cross-referencing graphic instances with default rendering options; and,
wherein selecting the second image rendering option for the selected first graphic instance includes using the UI to change from the default rendering option, to the second rendering option, for the first graphic instance.

12. The method of claim 3 wherein generating the print job incorporating the first and second image rendering options includes:
generating a print job with the default first image rendering option applied to the first graphic instance; and,
sending the second image rendering option, as applied to the first graphic instance, in a file appended to the print job.

13. The method of claim 12 further comprising:
sending the second image rendering option, as applied to the first graphic instance, in a file to the source document processing application as instructions for subsequent print data submissions.

14. A printer driver software application for selectively rendering graphic instances, the printer driver comprising:
a print processor component having an interface to accept print data from a source document processing software application and an interface to supply a print job;
a rendering user interface (UI) connected to the print processor component for selecting a first graphic instance in the print data; and,
wherein the print processor component generates a print job incorporating a first image rendering option as a default and automatically applying a second image rendering option to the first graphic instance.

15. The print driver of claim 14 wherein the rendering UI is used for selecting a graphic instance from the group comprising a text object, business graphics object, photo object, bitmap, color, a range of colors, an identified region of a page, and vector.

16. The print driver of claim 14 further comprising:
a storage medium for storing a print job-rendering template incorporating the second image rendering option for the selected first graphic instance;
wherein the rendering UI selects the job-rendering template from the storage medium; and,
wherein the print processor component accepts subsequent print data and generates a print job for the subsequent print data in response to the print job-rendering template.

17. The print driver of claim 14 wherein the rendering UI selects the second image rendering option for the selected first graphic instance from the group comprising halftoning, color management, black generation, undercolor removal, filters, color adjustments, and segmentation-based rendering algorithms.

18. The print driver of claim 14 wherein the rendering UI includes a display for visually previewing the print data and identifying a graphic instance.

19. The print driver of claim 18 wherein the rendering UI display depicts a UI graphic instance menu for accessing a list of graphic instances, selecting the first graphic instance from the list, accessing a list of image rendering options, and selecting the second image rendering option from the list, for association with the first graphic instance.

20. The print driver of claim 18 wherein the rendering UI display presents a hierarchical outline of segmented graphic instances differentiated by print job page number.

21. The print driver of claim 18 wherein the rendering UI selects graphic instances from the group comprising bitmaps differentiated by print job page number, bitmaps differentiated by sequence, text differentiated by print job page number, text differentiated by font, text differentiated by size, vectors differentiated by print job page number, vectors differentiated by shape, vectors differentiated by size, vectors differentiated by font, vectors differentiated by location of a print job page, and regions defined by closed vector shapes.

22. In a printer driver software application, a method for selectively rendering graphic instances in a print job, the method comprising:
accepting print data including a plurality of graphic instances, from a document processing software application;
applying a default first image rendering option to the print data;
selecting a first graphic instance in the print data;
applying a second image rendering option to the selected first graphic instance; and
generating an image job incorporating the first image rendering option, and automatically applying the second image rendering option to each identified occurrence of the first graphic instance.
